(19) United States
(12) Patent Application Publication
(10) Pub. No.: US 2025/0018936 A1
(43) Pub. Date: Jan. 16, 2025

(54) VEHICLE OPERATION USING THREAT NUMBERS

(71) Applicant: Ford Global Technologies, LLC, Dearborn, MI (US)

(72) Inventors: Christopher Pontisakos, Allen Park, MI (US); Yuhao Liu, Canton, MI (US); Alex Maurice Miller, Canton, MI (US)

(73) Assignee: Ford Global Technologies, LLC, Dearborn, MI (US)

(21) Appl. No.: 18/350,032

(22) Filed: Jul. 11, 2023

(51) Int. Cl. B60W 30/09; G08G 1/16

(52) U.S. Cl. CPC B60W 30/09; G08G 1/16; B60W 2520/125; B60W 2554/80

(57) ABSTRACT

A computer includes a processor and a memory, and the memory stores instructions executable by the processor to determine an availability metric, determine a maneuver metric, determine a threat number based on a comparison of the availability metric and the maneuver metric, and in response to the threat number exceeding a threshold, actuate a vehicle system to operate one of the first vehicle or the second vehicle. The availability metric is a kinematic quantity available to a first vehicle to perform an operation to maneuver the first vehicle away from a projected path of a second vehicle. The maneuver metric is a kinematic quantity estimated to be used by the first vehicle to perform the operation to maneuver the first vehicle away from the projected path of the second vehicle. The maneuver metric is measured in the same units as the availability metric.

### BACKGROUND

Advanced driver assistance systems (ADAS) are electronic technologies that assist drivers in driving and parking functions. Examples of ADAS include forward collision detection, lane-departure detection, blind-spot detection, automatic braking, adaptive cruise control, and lane-keeping assistance systems.

### BRIEF DESCRIPTION OF THE DRAWINGS

FIG. 1 is a block diagram of an example host vehicle.

FIG. 2 is a diagrammatic top view of an example interaction between the host vehicle and a target vehicle.

FIG. 3 is a diagrammatic top view of the interaction to illustrate a first threat number.

FIG. 4 is a diagrammatic top view of the interaction to illustrate a second threat number.

FIG. 5 is a flowchart of an example process for actuating the host vehicle based on the threat numbers.

### DETAILED DESCRIPTION

This disclosure describes techniques for determining threat numbers for actuating a host vehicle. A threat number indicates a level of risk of certain impacts between the host vehicle and a target vehicle, e.g., by indicating a capability of the host vehicle or target vehicle to maneuver before one or more of the certain impacts. A computer of the host vehicle determines a threat number based on a comparison of an availability metric and a maneuver metric. The availability metric is a kinematic quantity available to one of the host vehicle or target vehicle to perform an operation to maneuver that vehicle away from a projected path of the other of the host vehicle or target vehicle, i.e., how much of the kinematic quantity the situation affords to the vehicle. For example, the availability metric may be a distance from the host vehicle to the projected path of the target vehicle or a lateral acceleration needed to steer the host vehicle away from the projected path of the target vehicle. The computer may determine the availability metric based on a geometry of the potential interaction between the host vehicle and the target vehicle. The maneuver metric is the same kinematic quantity estimated to be used by the one of the host vehicle or the target vehicle to perform the operation to maneuver that vehicle away from the projected path of the other of the host vehicle or target vehicle, i.e., how much of the kinematic quantity the vehicle is capable of producing. For example, the maneuver metric may be a stopping distance of the vehicle or a lateral acceleration to maximally steer the host vehicle. The computer may determine the maneuver metric based on a kinematic state of the host vehicle (or target vehicle). The computer actuates a vehicle system, e.g., a brake system or a steering system, to operate the host vehicle in response to the threat number exceeding a threshold.

A computer includes a processor and a memory, and the memory stores instructions executable by the processor to determine an availability metric, determine a maneuver metric, determine a threat number based on a comparison of the availability metric and the maneuver metric, and in response to the threat number exceeding a threshold, actuate a vehicle system to operate one of the first vehicle or the second vehicle. The availability metric is a kinematic quantity available to a first vehicle to perform an operation to maneuver the first vehicle away from a projected path of a second vehicle. The maneuver metric is a kinematic quantity estimated to be used by the first vehicle to perform the operation to maneuver the first vehicle away from the projected path of the second vehicle. The maneuver metric is measured in the same units as the availability metric.

In an example, the second vehicle may include the vehicle system.

In an example, the first vehicle may include the vehicle system, and the instructions to actuate the vehicle system may include instructions to perform the operation.

In an example, the availability metric may be an available lateral acceleration of the first vehicle, and the maneuver metric may be a maneuver lateral acceleration of the first vehicle. In a further example, the threat number may include a ratio of the maneuver lateral acceleration and the available lateral acceleration.

In an example, the operation may include steering the first vehicle to an orientation parallel to the projected path of the second vehicle. In a further example, the operation may include following a circular path from a current position to a second position, and the first vehicle at the second position may have the orientation parallel to the projected path of the second vehicle. In a yet further example, the availability metric may be based on a radius of the circular path. In a still yet further example, the instructions may further include instructions to determine the radius based on a relative heading between the first vehicle and the second vehicle and based on a shortest distance from the first vehicle to the projected path of the second vehicle.

In another yet further example, the first vehicle in the second position may be spaced from the projected path of the second vehicle by a predefined distance.

In an example, the threat number may include an exponential function of an argument, and the argument may include the availability metric and the maneuver metric. In a further example, the argument may include a difference between the maneuver metric and the availability metric. In a yet further example, the instructions may further include instructions to determine a factor based on a speed of the first vehicle, and the argument may include a product of the difference and the factor.

In another yet further example, the instructions may further include instructions to determine a factor based on a turning status of the first vehicle, and the argument may include a product of the difference and the factor.

In another yet further example, the instructions may further include instructions to determine a factor based on a classification of the first vehicle, and the argument may include a product of the difference and the factor.

In another further example, the availability metric may be an available distance, and the maneuver metric may be a maneuver distance.

In an example, the threat number may be a first threat number, and the instructions may further include instructions to determine a second threat number; in response to both the first threat number and the second number exceeding the threshold, actuate the vehicle system to operate one of the first vehicle or the second vehicle; and in response to at least one of the first threat number and the second number being below the threshold, refrain from actuating the vehicle system to operate the one of the first vehicle or the second vehicle.

In an example, the vehicle system may be a brake system, and the operation may include braking.

In an example, the vehicle system may be a steering system, and the operation may include steering.

A method includes determining an availability metric, determining a maneuver metric, determining a threat number based on a comparison of the availability metric and the maneuver metric, and in response to the threat number exceeding a threshold, actuating a vehicle system to operate one of the first vehicle or the second vehicle. The availability metric is a kinematic quantity available to a first vehicle to perform an operation to maneuver the first vehicle away from a projected path of a second vehicle. The maneuver metric is a kinematic quantity estimated to be used by the first vehicle to perform the operation to maneuver the first vehicle away from the projected path of the second vehicle. The maneuver metric is measured in the same units as the availability metric.

With reference to the Figures, wherein like numerals indicate like parts throughout the several views, a computer 105 of a host vehicle 100 includes a processor and a memory. The memory of the computer 105 stores instructions executable by the processor to determine an availability metric, determine a maneuver metric, determine a threat number based on a comparison of the availability metric and the maneuver metric, and in response to the threat number exceeding a threshold, actuate a vehicle system to operate the host vehicle 100. The host vehicle 100 is one of a first vehicle 205 or a second vehicle 210. The availability metric is a kinematic quantity available to the first vehicle 205 to perform an operation to maneuver the first vehicle 205 away from a projected path 215 of the second vehicle 210. The maneuver metric is a kinematic quantity estimated to be used by the first vehicle 205 to perform the operation to maneuver the first vehicle 205 away from the projected path 215 of the second vehicle 210. The maneuver metric is measured in the same units as the availability metric.

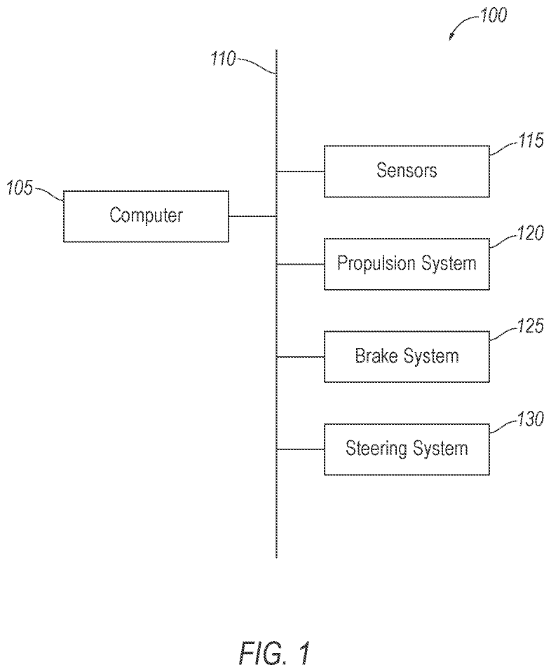

With reference to FIG. 1, the host vehicle 100 may be any passenger or commercial automobile such as a car, a truck, a sport utility vehicle, a crossover, a van, a minivan, a taxi, a bus, etc. The host vehicle 100 includes the computer 105, a communications network 110, sensors 115, and vehicle systems including a propulsion system 120, a brake system 125, and a steering system 130.

The computer 105 is a microprocessor-based computing device, e.g., a generic computing device including a processor and a memory, an electronic controller or the like, a field-programmable gate array (FPGA), an application-specific integrated circuit (ASIC), a combination of the foregoing, etc. Typically, a hardware description language such as VHDL (VHSIC (Very High Speed Integrated Circuit) Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected to the FPGA circuit. The computer 105 can thus include a processor, a memory, etc. The memory of the computer 105 can include media for storing instructions executable by the processor as well as for electronically storing data and/or databases, and/or the computer 105 can include structures such as the foregoing by which programming is provided. The computer 105 can be multiple computers coupled together.

The computer 105 may transmit and receive data through the communications network 110. The communications network 110 may be, e.g., a controller area network (CAN) bus, Ethernet, WiFi, Local Interconnect Network (LIN), onboard diagnostics connector (OBD-II), and/or any other wired or wireless communications network. The computer 105 may be communicatively coupled to the sensors 115, the propulsion system 120, the brake system 125, the steering system 130, and other vehicle systems and components via the communications network 110.

The sensors 115 may provide data about operation of the host vehicle 100, for example, wheel speed, wheel orientation, and engine and transmission data (e.g., temperature, fuel consumption, etc.). The sensors 115 may detect the location and/or orientation of the host vehicle 100. For example, the sensors 115 may include global positioning system (GPS) sensors; accelerometers such as piezo-electric or microelectromechanical systems (MEMS); gyroscopes such as rate, ring laser, or fiber-optic gyroscopes; inertial measurements units (IMU); and magnetometers. The sensors 115 may detect the external world, e.g., objects and/or characteristics of surroundings of the host vehicle 100, such as other vehicles (i.e., target vehicles), road lane markings, traffic lights and/or signs, pedestrians, etc. For example, the sensors 115 may include radar sensors, ultrasonic sensors, scanning laser range finders, light detection and ranging (lidar) devices, and image processing sensors such as cameras.

The propulsion system 120 of the host vehicle 100 generates energy and translates the energy into motion of the host vehicle 100. The propulsion system 120 may be a conventional vehicle propulsion subsystem, for example, a conventional powertrain including an internal-combustion engine coupled to a transmission that transfers rotational motion to wheels; an electric powertrain including batteries, an electric motor, and a transmission that transfers rotational motion to the wheels; a hybrid powertrain including elements of the conventional powertrain and the electric powertrain; or any other type of propulsion. The propulsion system 120 can include an electronic control unit (ECU) or the like that is in communication with and receives input from the computer 105 and/or a human operator. The human operator may control the propulsion system 120 via, e.g., an accelerator pedal and/or a gear-shift lever.

The brake system 125 is typically a conventional vehicle braking subsystem and resists the motion of the host vehicle 100 to thereby slow and/or stop the host vehicle 100. The brake system 125 may include friction brakes such as disc brakes, drum brakes, band brakes, etc.; regenerative brakes; any other suitable type of brakes; or a combination. The brake system 125 can include an electronic control unit (ECU) or the like that is in communication with and receives input from the computer 105 and/or a human operator. The human operator may control the brake system 125 via, e.g., a brake pedal.

The steering system 130 is typically a conventional vehicle steering subsystem and controls the turning of the wheels. The steering system 130 may be a rack-and-pinion system with electric power-assisted steering, a steer-by-wire system, as both are known, or any other suitable system. The steering system 130 can include an electronic control unit (ECU) or the like that is in communication with and receives input from the computer 105 and/or a human operator. The human operator may control the steering system 130 via, e.g., a steering wheel.

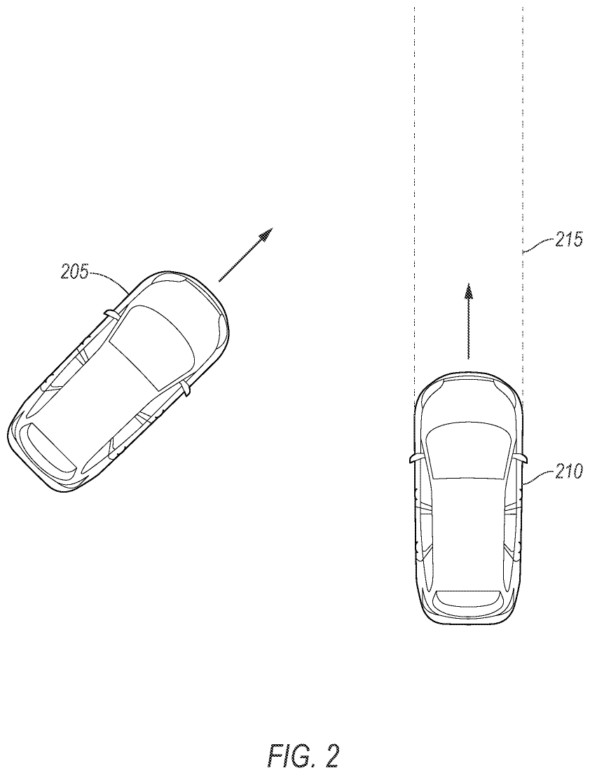

With reference to FIG. 2, a first vehicle 205 and a second vehicle 210 may be located in a same environment, e.g., driving on the same street or intersecting streets. The first vehicle 205 may have a trajectory that intersects a projected path 215 of the second vehicle 210. The projected path 215 is an area that is predicted to be traveled over by the second vehicle 210, i.e., a ground area that will be swept by the second vehicle 210 as the second vehicle 210 travels. One of the first vehicle 205 or the second vehicle 210 is the host vehicle 100, i.e., the vehicle under the control of the computer 105, for which the determinations and actuations below are described. The other of the first vehicle 205 or the second vehicle 210 is a target vehicle, which is not under the control of the computer 105. The computer 105 of the host vehicle 100 determines a threat number and uses the threat number to actuate a vehicle system of the host vehicle 100 to attempt to maneuver the host vehicle 100 away from intersecting the target vehicle, as will be described in more detail below.

The computer 105 may be programmed to determine the projected path 215 of the second vehicle 210. For example, the computer 105 may determine a width of the second vehicle 210 based on data from the sensors 115, e.g., a radar or lidar, or based on a prestored value. The computer 105 may determine a trajectory, e.g., a direction of a velocity vector of the second vehicle 210, based on data from the sensors 115. If the second vehicle 210 is the target vehicle, the computer 105 may determine the trajectory based on data from radar or lidar indicating a change in the position of the second vehicle 210 over time. If the second vehicle 210 is the host vehicle 100, the computer 105 may receive the trajectory from, e.g., an IMU of the sensors 115. The computer 105 may project the width of the second vehicle 210 from a current position of the second vehicle 210 in the direction of the trajectory of the second vehicle 210 to generate the projected path 215.

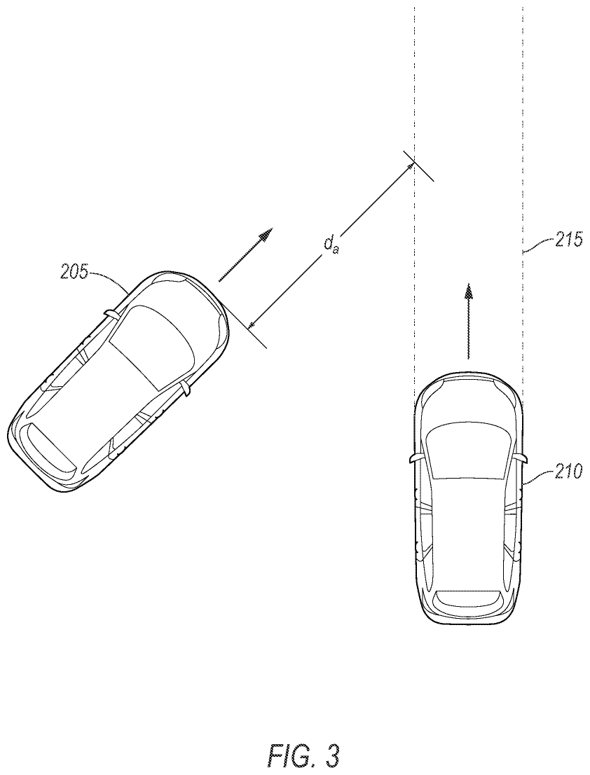

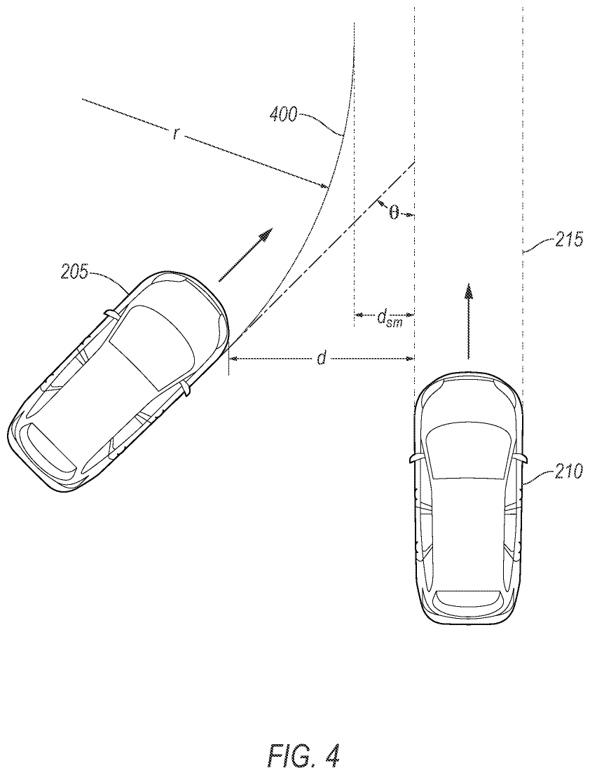

The first vehicle 205 can perform an operation to maneuver the first vehicle 205 away from the projected path 215 of the second vehicle 210. Multiple potential operations may be considered, as will be described below. The operation may include braking and/or steering. For example, the operation may include actuating the brake system 125 of the first vehicle 205 until the first vehicle 205 has stopped (as described below with respect to FIG. 3), or the operation may include actuating the steering system 130 of the first vehicle 205 until the trajectory of the first vehicle 205 is parallel to the projected path 215 of the second vehicle 210 (as described below with respect to FIG. 4). The potential operations may be stored in the memory of the computer 105. The computer 105 may determine an availability metric and a maneuver metric for each potential operation.

The computer 105 is programmed to determine an availability metric for each potential operation. The availability metric is a kinematic quantity available to the first vehicle 205 to perform the operation to maneuver the first vehicle 205 away from the projected path 215 of the second vehicle 210, i.e., how much of the kinematic quantity the situation provides for the first vehicle 205 to use in order to not intersect the projected path 215 of the second vehicle 210. For example, the availability metric may be a distance in the direction of travel of the first vehicle 205 from the first vehicle 205 to the projected path 215 of the second vehicle 210. For another example, the availability metric may be a lateral acceleration needed to turn the first vehicle 205 to be parallel to the projected path 215 of the second vehicle 210 before the first vehicle 205 reaches the projected path 215. The computer 105 may determine the availability metric based on a geometric and/or kinematic analysis of the first vehicle 205 and the second vehicle 210, as will be described below for specific examples.

The computer 105 is programmed to determine a maneuver metric for each potential operation. The maneuver metric is a kinematic quantity estimated to be used by the first vehicle 205 to perform the operation to maneuver the first vehicle 205 away from the projected path 215 of the second vehicle 210, i.e., the kinematic quantity that the first vehicle 205 is capable of producing. For example, the maneuver metric may be a stopping distance for the first vehicle 205. For another example, the maneuver metric may be a predetermined maximum lateral acceleration. The maneuver metric is measured in the same units as the availability metric for the respective operation, thereby facilitating a comparison between the maneuver metric and the availability metric. For example, the maneuver metric is the same kinematic quantity as the availability metric for the respective operation, e.g., a distance forward from the first vehicle 205 or a lateral acceleration of the first vehicle 205. The computer 105 may determine the maneuver metric based on a kinematic state of the first vehicle 205.

The computer 105 is programmed to determine a threat number for each potential operation based on a comparison of the respective availability metric and the respective maneuver metric. The comparison may be, e.g., a ratio between the maneuver metric and the availability metric, a difference between the maneuver metric and the availability metric, etc., as will be described for specific examples below.

The computer 105 is programmed to compare the threat number to a threshold and, in response to the threat number exceeding the threshold, actuate a vehicle system of the host vehicle 100 to operate the host vehicle 100. In the case of multiple potential operations, the computer 105 may be programmed to actuate the vehicle system in response to all of the threat numbers exceeding the threshold. The computer 105 may be programmed to, in response to at least one of the threat numbers being below the threshold, refrain from actuating the vehicle system to operate the host vehicle 100. The threshold may be chosen to provide a margin before the maneuver metric reaches the availability metric. For example, the determinations of the threat numbers for the potential operations may be calibrated so that each threat number equals 1 when the respective maneuver metric equals the respective availability metric, and the threshold may be chosen to be 0.7. A threat number being below the threshold can indicate that an operator of the first vehicle 205 has sufficient time to perform the respective operation, i.e., the operation corresponding to that threat number.

The vehicle system may include the brake system 125 and/or the steering system 130. Actuating the vehicle system may include actuating the brake system 125, i.e., applying the brakes, and/or actuating the steering system 130, i.e., turning the host vehicle 100. For example, if the host vehicle 100 is the first vehicle 205, actuating the vehicle system may include performing the operation corresponding to the threat number. The computer 105 may actuate the vehicle system to perform the operation corresponding to the lowest threat number, i.e., the threat number that exceeds the threshold by the least amount. If the host vehicle 100 is the second vehicle 210, the computer 105 may actuate the vehicle system in a predetermined manner, e.g., actuating the brake system 125 to brake the host vehicle 100 to a stop.

FIG. 3 illustrates a specific example of a threat number, which will be referred to as the distance-based threat number. The potential operation for the distance-based threat number is braking the first vehicle 205 to a stop.

The availability metric for the distance-based threat number is an available distance. The computer 105 may be programmed to determine the available distance. The available distance may be, e.g., a longitudinal distance from a closest point on the first vehicle 205 to the projected path 215 of the second vehicle 210. The available distance is longitudinal in that the available distance is measured along a forward direction of the first vehicle 205. The closest point may be a front corner of the first vehicle 205.

If the host vehicle 100 is the second vehicle 210, the computer 105 may be programmed to classify the first vehicle 205. The computer 105 can classify the first vehicle 205 using conventional image-recognition techniques, e.g., a convolutional neural network programmed to accept images as input and output an identified type of vehicle. Possible types of vehicles may include bicycle, consumer motor vehicle, commercial vehicle, etc. A convolutional neural network includes a series of layers, with each layer using the previous layer as input. Each layer contains a plurality of neurons that receive as input data generated by a subset of the neurons of the previous layers and generate output that is sent to neurons in the next layer. Types of layers include convolutional layers, which compute a dot product of a weight and a small region of input data; pool layers, which perform a downsampling operation along spatial dimensions; and fully connected layers, which generate based on the output of all neurons of the previous layer. The final layer of the convolutional neural network generates a score for each potential type of vehicle, and the final output is the type of vehicle with the highest score.

The maneuver metric for the distance-based threat number is a maneuver distance. The computer 105 may be programmed to determine the maneuver distance based on a model of the brake system 125 of the first vehicle 205. For example, the maneuver distance according the model may be a sum of a distance traveled while actively braking and a distance traveled at a current speed for a brake-delay time, as in the following equation:

$${d}_{m} = \frac{{v}^{2}}{2 {a}_{max Reached}} + {t}_{BDtot} v$$

in which dₘ is the maneuver distance, v is the current speed of the first vehicle 205, a_{maxReached} is the maximum deceleration reached, and t_{BDtot} is the total brake-delay time. The value of the maximum deceleration depends on whether the first vehicle 205 is projected to reach zero speed while the deceleration is increasing (i.e., during a ramp-up period) or to reach zero after a maximum deceleration has been reached. The time to reach zero speed during the ramp-up period may be given in the following equation:

$${t}_{jerkStop} = \sqrt{\frac{2 v}{j}}$$

in which j is the jerk, i.e., the derivative of acceleration. The time to reach the maximum deceleration is given by the following equation: t_{reachMax}−aₘₐₓ/j, in which aₘₐₓ is the maximum deceleration of the first vehicle 205. If the host vehicle 100 is the first vehicle 205, the computer 105 may store a value for the maximum deceleration aₘₐₓ in memory. If the host vehicle 100 is the second vehicle 210, the computer 105 may determine the maximum deceleration aₘₐₓ based on the classification of the first vehicle 205, e.g., by consulting a lookup table pairing classifications (e.g., bicycle, consumer motor vehicle, commercial vehicle, etc.) with corresponding maximum decelerations aₘₐₓ. If the time to reach the maximum deceleration aₘₐₓ is less than the time to reach zero speed during increasing deceleration, i.e., if t_{reachMax}<t_{jerkStop}, then the maximum acceleration reached a_{maxReached} is the maximum deceleration aₘₐₓ. If the time to reach zero speed during increasing acceleration is less than the time to reach the maximum deceleration, i.e., if t_{jerkStop}<t_{reachMax}, then the maximum acceleration reached is given by the following equation: a_{maxReached}t_{jerkStop}/j. The total brake-delay time may include a preset reaction time and a deceleration ramp-up time, e.g., as in the following equation:

$${t}_{BCtot} = {t}_{react} + \frac{1}{2} min ( {t}_{jerkStop} , {t}_{reachMax} )$$

in which t_{react} is the preset reaction time.

The computer 105 may be programmed to determine a factor based on one or more characteristics of the first vehicle 205. The factor is a numerical quantity that will be used to determine the distance-based threat number, as described below. The computer 105 may determine the factor based on the speed of the first vehicle 205, a turning status of the first vehicle 205, the classification of the first vehicle 205, etc. For example, the factor may decrease with increasing speed v of the first vehicle 205, which results in larger stopping distances at higher speeds. For another example, the factor may decrease when the first vehicle 205 is turning compared to when the first vehicle 205 is traveling straight, to account for over-approximation of the available distance that may occur when the first vehicle 205 is turning. For another example, when the host vehicle 100 is the second vehicle 210, the factor may be adjusted based on the classification of the first vehicle 205 to account for different typical stopping distances for different types of vehicles.

The computer 105 may be programmed to determine the distance-based threat number. The distance-based threat number may include an exponential function of an argument that includes the available distance and the maneuver distance. The term “exponential function” has its mathematical sense of Euler's number e raised to the power of the argument. The argument may include a difference between the available distance and the maneuver distance, e.g., a product of that difference and the factor λ, as in the following equation:

DBTN=exp(λ(dₘ−dₐ)

in which DBTN is the distance-based threat number, exp( ) is the exponential function, is the factor, dₘ is the maneuver distance, and dₐ is the available distance. The use of the exponential function may provide intuitive, predictable behavior of the distance-based threat number while the first vehicle 205 approaches the projected path 215 of the second vehicle 210, with the distance-based threat number increasing as the first vehicle 205 gets closer to the projected path 215 even as an operator actuates the brake system 125 of the first vehicle 205. For comparison, time to collision (TTC) can increase as the operator brakes the first vehicle 205, even though the first vehicle 205 would be getting closer to the second vehicle 210.

The computer 105 may determine two distance-based threat numbers, a first distance-based threat number for the host vehicle 100 and a second distance-based threat number for the target vehicle. The computer 105 may determine the first distance-based threat number in the manner described above, treating the host vehicle 100 as the first vehicle 205 and the target vehicle as the second vehicle 210, i.e., a distance-based threat number assessing the ability of the host vehicle 100 to stop. The computer 105 may determine a second distance-based threat number in the manner described above, treating the target vehicle as the first vehicle 205 and the host vehicle 100 as the second vehicle 210, i.e., a distance-based threat number assessing the ability of the target vehicle to stop.

The computer 105 may be programmed to actuate a vehicle system of the host vehicle 100 in response to the distance-based threat number (along with any other threat numbers) exceeding the threshold. More specifically, the computer 105 may actuate the vehicle system in response to both the first distance-based threat number and the second distance-based threat number (along with any other threat numbers) exceeding the threshold. For example, the computer 105 may actuate the brake system 125 by braking the host vehicle 100 to a stop.

FIG. 4 illustrates another specific example of a threat number, which will be referred to as the yaw threat number. The potential operation for the yaw threat number is steering the first vehicle 205 to an orientation parallel to the projected path 215 of the second vehicle 210. The operation may include following a circular path 400 from a current position to a second position, with the first vehicle 205 at the second position having the orientation parallel to the projected path 215 of the second vehicle 210. The first vehicle 205 in the second position may be spaced from the projected path 215 of the second vehicle 210 by a predefined distance. The predefined distance may be chosen to provide a margin between the first vehicle 205 at the second position and the projected path 215 of the second vehicle 210.

The computer 105 may be programmed to determine a radius of the circular path 400 based on a relative heading between the first vehicle 205 and the second vehicle 210, a shortest distance from the first vehicle 205 to the projected path 215 of the second vehicle 210, the predefined distance, and possibly a steering-wheel angle of the first vehicle 205 (or, equivalently, a steering angle of the first vehicle 205). For example, the radius may be given by the following equation:

$$r = \frac{d - {d}_{sm}}{1 - cos ( θ - \frac{SWA}{SR} )}$$

in which d is the shortest distance from the first vehicle 205 to the projected path 215 of the second vehicle 210, dₛₘ is the predefined distance, θ is the relative heading between the first vehicle 205 and the second vehicle 210, SWA is the steering-wheel angle of the first vehicle 205, and SR is the steering ratio of the first vehicle 205. The term SWA/SR may be replaced by the steering angle SA. The steering-wheel angle term or steering-angle term can compensate for steering effort by an operator of the first vehicle 205 and may alternatively be omitted.

The availability metric for the yaw threat number is an available lateral acceleration of the first vehicle 205. The computer 105 may be programmed to determine the available lateral acceleration, e.g., based on a physics model of acceleration for following a circular path 400, e.g., as given in the following equation:

$${a}_{latA} = \frac{{v}^{2}}{r}$$

in which a_{latA} is the available lateral acceleration of the first vehicle 205, v is the speed of the first vehicle 205, and r is the radius of the circular path 400 determined above. The use of the circular path 400 permits the calculation of the radius r and the available lateral acceleration a_{latA} with simple formulas that use quantities known to the computer 105, while still accurately describing the space afforded by the situation for the first vehicle 205 to turn.

The maneuver metric for the yaw threat number is a maneuver lateral acceleration of the first vehicle 205. The computer 105 may be programmed to determine the maneuver lateral acceleration. For example, the maneuver lateral acceleration may be a predefined value stored in the memory of the computer 105. The predefined maneuver lateral acceleration may be chosen based on a maximum lateral acceleration at which a turn still feels comfortable to a typical operator of the first vehicle 205.

The computer 105 may be programmed to determine the yaw threat number. The yaw threat number may include a ratio of the available lateral acceleration and the maneuver lateral acceleration, e.g., as in the following equation:

YTN=a_{latA}/a_{latM}

in which YTN is the yaw threat number, a_{latA} is the available lateral acceleration, and a_{latM} is the maneuver lateral acceleration. The computer 105 may determine the yaw threat number treating the host vehicle 100 as the first vehicle 205 and the target vehicle as the second vehicle 210.

The computer 105 may be programmed to actuate a vehicle system of the host vehicle 100 in response to the yaw threat number (along with any other threat numbers) exceeding the threshold. For example, the computer 105 may actuate the steering system 130 to perform the operation, i.e., to steer the host vehicle 100 along the circular path 400.

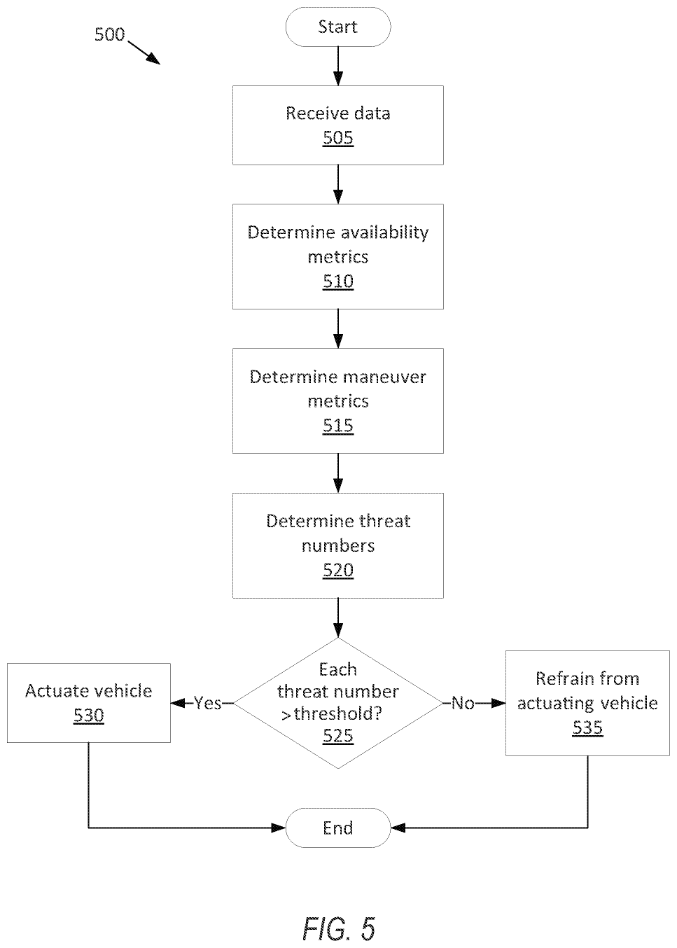

FIG. 5 is a flowchart illustrating an example process 500 for actuating the host vehicle 100 based on the threat numbers. The memory of the computer 105 stores executable instructions for performing the steps of the process 500 and/or programming can be implemented in structures such as mentioned above. The computer 105 may perform the process 500 continuously while target vehicles are in the vicinity of the host vehicle 100. As a general overview of the process 500, the computer 105 receives data from the sensors 115, determines the availability metrics for the respective threat numbers, determines the maneuver metrics for the respective threat numbers, and determines the threat numbers based on the respective availability metrics and maneuver metrics. In response to all the threat numbers exceeding the threshold, the computer 105 actuates a vehicle system of the host vehicle 100 to operate the host vehicle 100. In response to at least one of the threat numbers being below the threshold, the computer 105 refrains from actuating the vehicle system to operate the host vehicle 100.

The process 500 begins in a block 505, in which the computer 105 receives data from the sensors 115. The data may indicate the kinematic states of the host vehicle 100 and the target vehicle, from which the availability metrics and maneuver metrics may be determined.

Next, in a block 510, the computer 105 determines the availability metrics, e.g., the available distance for the host vehicle 100, the available distance for the target vehicle, and the available lateral acceleration for the host vehicle 100, as described above.

Next, in a block 515, the computer 105 determines the maneuver metrics, e.g., the maneuver distance for the host vehicle 100, the maneuver distance for the target vehicle, and the maneuver lateral acceleration for the host vehicle 100, as described above.

Next, in a block 520, the computer 105 determines the threat numbers, e.g., the distance-based threat number for the host vehicle 100, the distance-based threat number for the target vehicle, and the yaw threat number for the host vehicle 100, as described above.

Next, in a decision block 525, the computer 105 determines whether each threat number exceeds the threshold, as described above. In response to all the threat numbers exceeding the threshold, the process 500 proceeds to a block 530. In response to at least one of the threat numbers being below the threshold, the process 500 proceeds to a block 535.

In the block 530, the computer 105 actuates a vehicle system of the host vehicle 100 to operate the host vehicle 100, as described above. After the block 530, the process 500 ends.

In the block 535, the computer 105 refrains from actuating the vehicle system of the host vehicle 100 to operate the host vehicle 100, as described above. After the block 535, the process 500 ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. Operations, systems, and methods described herein should always be implemented and/or performed in accordance with an applicable owner's/user's manual and/or safety guidelines.

The disclosure has been described in an illustrative manner, and it is to be understood that the terminology which has been used is intended to be in the nature of words of description rather than of limitation. The adjectives “first” and “second” are used throughout this document as identifiers and are not intended to signify importance, order, or quantity. Use of “in response to,” “upon determining,” etc. indicates a causal relationship, not merely a temporal relationship. Many modifications and variations of the present disclosure are possible in light of the above teachings, and the disclosure may be practiced otherwise than as specifically described.

What is claimed is:

1. A computer comprising a processor and a memory, the memory storing instructions executable by the processor to:
determine an availability metric, the availability metric being a kinematic quantity available to a first vehicle to perform an operation to maneuver the first vehicle away from a projected path of a second vehicle;
determine a maneuver metric, the maneuver metric being a kinematic quantity estimated to be used by the first vehicle to perform the operation to maneuver the first vehicle away from the projected path of the second vehicle, the maneuver metric being measured in the same units as the availability metric;
determine a threat number based on a comparison of the availability metric and the maneuver metric; and
in response to the threat number exceeding a threshold, actuate a vehicle system to operate one of the first vehicle or the second vehicle.

2. The computer of claim 1, wherein the second vehicle includes the vehicle system.

3. The computer of claim 1, wherein the first vehicle includes the vehicle system, and the instructions to actuate the vehicle system include instructions to perform the operation.

4. The computer of claim 1, wherein the availability metric is an available lateral acceleration of the first vehicle, and the maneuver metric is a maneuver lateral acceleration of the first vehicle.

5. The computer of claim 4, wherein the threat number includes a ratio of the maneuver lateral acceleration and the available lateral acceleration.

6. The computer of claim 1, wherein the operation includes steering the first vehicle to an orientation parallel to the projected path of the second vehicle.

7. The computer of claim 6, wherein the operation includes following a circular path from a current position to a second position, the first vehicle at the second position having the orientation parallel to the projected path of the second vehicle.

8. The computer of claim 7, wherein the availability metric is based on a radius of the circular path.

9. The computer of claim 8, wherein the instructions further include instructions to determine the radius based on a relative heading between the first vehicle and the second vehicle and based on a shortest distance from the first vehicle to the projected path of the second vehicle.

10. The computer of claim 7, wherein the first vehicle in the second position is spaced from the projected path of the second vehicle by a predefined distance.

11. The computer of claim 1, wherein the threat number includes an exponential function of an argument, the argument including the availability metric and the maneuver metric.

12. The computer of claim 11, wherein the argument includes a difference between the maneuver metric and the availability metric.

13. The computer of claim 12, wherein the instructions further include instructions to determine a factor based on a speed of the first vehicle, and the argument includes a product of the difference and the factor.

14. The computer of claim 12, wherein the instructions further include instructions to determine a factor based on a turning status of the first vehicle, and the argument includes a product of the difference and the factor.

15. The computer of claim 12, wherein the instructions further include instructions to determine a factor based on a classification of the first vehicle, and the argument includes a product of the difference and the factor.

16. The computer of claim 11, wherein the availability metric is an available distance, and the maneuver metric is a maneuver distance.

17. The computer of claim 1, wherein the threat number is a first threat number, and the instructions further include instructions to:
determine a second threat number;
in response to both the first threat number and the second number exceeding the threshold, actuate the vehicle system to operate one of the first vehicle or the second vehicle; and
in response to at least one of the first threat number and the second number being below the threshold, refrain from actuating the vehicle system to operate the one of the first vehicle or the second vehicle.

18. The computer of claim 1, wherein the vehicle system is a brake system, and the operation includes braking.

19. The computer of claim 1, wherein the vehicle system is a steering system, and the operation includes steering.

20. A method comprising:
determining an availability metric, the availability metric being a kinematic quantity available to a first vehicle to perform an operation to maneuver the first vehicle away from a projected path of a second vehicle;
determining a maneuver metric, the maneuver metric being a kinematic quantity estimated to be used by the first vehicle to perform the operation to maneuver the first vehicle away from the projected path of the second vehicle, the maneuver metric being measured in the same units as the availability metric;
determining a threat number based on a comparison of the availability metric and the maneuver metric; and
in response to the threat number exceeding a threshold, actuating a vehicle system to operate one of the first vehicle or the second vehicle.
